(19) United States
(12) Patent Application Publication
(10) Pub. No.: US 2026/0326812 A1
(43) Pub. Date: Oct. 22, 2026

(54) OPERATION CONTROL DEVICE AND INPUT DEVICE

(71) Applicants: KABUSHIKI KAISHA TOKAI RIKA DENKI SEISAKUSHO, Aichi (JP); TOYOTA JIDOSHA KABUSHIKI KAISHA, Aichi-ken (JP)

(72) Inventors: Yasutaka MATSUDA, Aichi (JP); Yusuke KUMAKIRI, Aichi (JP); Kana KATASHIMA, Aichi (JP); Takeshi OHNISHI, Aichi (JP); Hideaki TAKEDA, Aichi (JP); Shumpei SUGIMURA, Kasugai-shi, Aichi-ken (JP); Satoshi YAMAMICHI, Nagoya-shi, Aichi-ken (JP); Yoshimasa MIURA, Toyota-shi, Aichi-ken (JP); Yoshiyuki MURAMATSU, Aichi-gun, Aichi-ken (JP); Kei YAMAMOTO, Toyota-shi, Aichi-ken (JP)

(73) Assignees: KABUSHIKI KAISHA TOKAI RIKA DENKI SEISAKUSHO, Aichi (JP); TOYOTA JIDOSHA KABUSHIKI KAISHA, Aichi-ken (JP)

(21) Appl. No.: 19/653,642

(22) Filed: Apr. 21, 2026

(30) Foreign Application Priority Data
Apr. 22, 2025 (JP) 2025-070166

(51) Int. Cl. B62D 1/04; B62D 1/06

(52) U.S. Cl. CPC B62D 1/046; B62D 1/06

(57) ABSTRACT

A first number (no less than three) of operation accepting areas are associated with different controlled operations. Each of a second number (no greater than the first number) of border forming members has a protruded shape. The operation accepting areas are disposed so as to surround a central area. The border forming members extend radially from the central area. Each of the border forming members defines a border of two adjacent ones of the operation accepting areas. One of the border forming members forms, together with another one of the border forming members, a borderless portion having a width to such an extent that a finger of the driver is not allowed to move to the central area from each of the two adjacent operation accepting areas.

### CROSS-REFERENCE TO RELATED APPLICATION

The present application is based on Japanese Patent Application No. 2025-070166 filed on Apr. 22, 2025, the entire contents of which are incorporated herein by reference.

### BACKGROUND

The presently disclosed subject matter relates to an operation control device equipped with a processing device adapted to control an operation of a controlled device. The presently disclosed subject matter also relates to an input device adapted to be equipped with the operation control device.

Japanese Patent Publication No. 2023-148568A discloses a steering device as an exemplary operation control device that is adapted to be installed in a vehicle as an exemplary mobility. The steering device includes a steering member configured to be rotated about a rotation axis to change a traveling direction of the vehicle. An input device is disposed on the steering member. The input device includes multiple operation accepting areas. The operation accepting areas are associated with different operations of at least one controlled device.

### SUMMARY

There is a need for improving the convenience of an operation control device equipped with an input device adapted to control multiple operations of a controlled device.

An illustrative aspect of the presently disclosed subject matter may provide an operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a direction along the rotation axis,
wherein the input device includes:
   a first number of operation accepting areas associated with different second controlled operations, the first number being no less than three; and
   a second number of border forming members each having a protruded shape, the second number being no greater than the first number;
wherein the operation accepting areas are disposed so as to surround a central area;
wherein the border forming members extend radially from the central area;
wherein each of the border forming members defines a border of two adjacent ones of the operation accepting areas;
wherein one of the border forming members forms, together with another one of the border forming members, a borderless portion having a width to such an extent that a finger of the driver is not allowed to move to the central area from each of the two adjacent ones of the operation accepting areas.

An illustrative aspect of the presently disclosed subject matter may provide an input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a direction along the rotation axis, and comprising:
a first number of operation accepting areas associated with different second controlled operations, the first number being no less than three; and
a second number of border forming members each having a protruded shape, the second number being no greater than the first number,
wherein the operation accepting areas are disposed so as to surround a central area;
wherein the border forming members extend radially from the central area;
wherein each of the border forming members defines a border of two adjacent ones of the operation accepting areas;
wherein one of the border forming members forms, together with another one of the border forming members, a borderless portion having a width to such an extent that a finger of the driver is not allowed to move to the central area from each of the two adjacent ones of the operation accepting areas.

In order to prevent unintended contact or movement of the finger to a certain operation accepting area, it is conceivable that each of the operation accepting areas is surrounded so as to avoid formation of borderless portion. However, since such a configuration exhibits a complicated or crowded appearance, not only the product appeal would be diminished, but also the manufacturing cost would be increased due to complexity of the structure.

On the other hand, according to the configuration of each of the illustrative aspects, each of the border forming members can restrict the movement of the finger between the adjacent operation accepting areas. In addition, it is possible to restrict the movement of the finger from each operation accepting area to the center area while forming the borderless portion between each operation accepting area and the center area. As a result, although the unintended contact or movement of the finger to a certain operation accepting area can be prevented, not only the product appeal can be improved with a sophisticated appearance, but also the increase of the manufacturing cost can be suppressed with a simplified structure. Accordingly, it is possible to improve the convenience of an operation control device equipped with an input device adapted to control multiple operations of the controlled device.

### DESCRIPTION OF THE DRAWINGS

FIG. 1 illustrates a steering device according to an exemplary embodiment.

FIG. 2 illustrates an appearance of an input device adapted to be equipped with the steering device of FIG. 1.

FIG. 3 illustrates a part of the input device of FIG. 2 in an enlarged manner.

FIG. 4 illustrates an appearance of a comparative exemplary input device.

FIG. 5 illustrates another exemplary shape of the border forming member of FIG. 2.

FIG. 6 illustrates another exemplary shape of the border forming member of FIG. 2.

FIG. 7 illustrates another exemplary shape of the border forming member of FIG. 2.

FIG. 8 illustrates a cross-section along the line VIII-VIII in FIG. 7 when viewed from an arrowed direction.

FIG. 9 illustrates a cross-section along the line IX-IX in FIG. 7 when viewed from an arrowed direction.

FIG. 10 illustrates another exemplary shape of the border forming member of FIG. 2.

FIG. 11 illustrates an appearance of another exemplary input device.

### DESCRIPTION OF EMBODIMENTS

Exemplary embodiments will be described in detail below with reference to the accompanying drawings. In the drawings used in the following descriptions, the scale thereof is changed as required in order to make each element to a recognizable size.

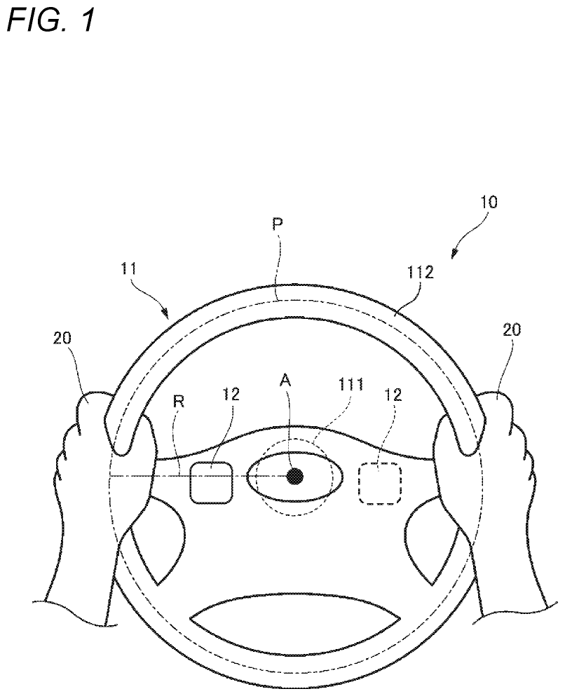

FIG. 1 illustrates an appearance of a steering device 10 according to an exemplary embodiment. The steering device 10 is a device adapted to be disposed in a cabin of a vehicle to cause the vehicle to perform an operation of changing a traveling direction. The steering device 10 is an exemplary operation control device. The operation of changing the traveling direction is an exemplary first controlled operation. The vehicle is an exemplary mobility.

The steering device 10 includes a steering member 11. The steering member 11 includes a shaft 111 and a grip 112. The shaft 111 is adapted to be rotated about a rotation axis A. The grip 112 is adapted to be gripped by a driver's hand 20. The driver is an exemplary user. The grip 112 is adapted to be turned along a turning path P about the rotation axis A. As the grip 112 is turned by the driver's hand 20, the shaft 111 rotates in the same direction. The rotation direction is associated with the traveling direction of the vehicle to be changed.

The steering device 10 includes an input device 12. The input device 12 is disposed between the shaft 111 and the grip 112 when viewed from a direction along the rotation axis A.

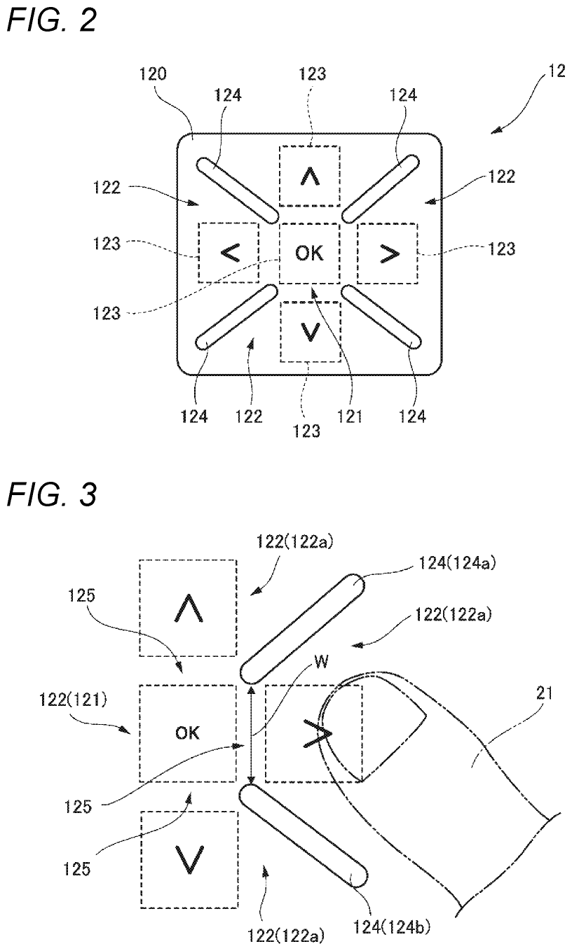

FIG. 2 illustrates an appearance of the input device 12 when viewed from the direction along the rotation axis A. The input device 12 includes an operation accepting face 120. The operation accepting face 120 is disposed at a position where a finger of a driver's hand holding the grip 112 of the steering member 11 can reach.

The operation accepting face 120 includes a central area 121 and multiple operation accepting areas 122. Each of the multiple operation accepting areas 122 is associated with an operation of a controlled device installed in the vehicle. In other words, the multiple operation accepting areas 122 are associated with different operations related to the controlled device.

Examples of the controlled device include a device for adjusting a position of equipment installed in a vehicle (a seat, a steering device, a window, a rearview mirror, and the like), a lighting device, an air conditioner, and an audio-visual device. The above “different operations” may be different operations of an identical controlled device, or operations of different controlled devices. The multiple operations associated with the multiple operation accepting areas 122 are an exemplary multiple second controlled operations.

The multiple operation accepting areas 122 are disposed so as to surround the central area 121. In this example, one of the multiple operation accepting areas 122 is also disposed in the central area 121.

In this example, each of the multiple operation accepting areas 122 is provided with no physical border structure with respect to other areas in the operation accepting face 120. In other words, each of the multiple operation accepting areas 122 is flush with the operation accepting face 120.

In each of the multiple operation accepting areas 122, an icon is provided so that the driver can recognize the associated operation of the controlled device. The icon may be configured with at least one of characters, numerals, symbols, graphics, pictures, and colors.

The input device 12 includes multiple electrodes 123. The multiple electrodes 123 are disposed behind the operation accepting face 120. Each of the electrodes 123 is associated with one of the multiple operation accepting areas 122. Each of the multiple electrodes 123 is provided for detecting change in electrostatic capacitance caused by approach or contact of a driver's finger with respect to an associated operation accepting area 122.

The input device 12 includes a processing device (not illustrated). The processing device is implemented by a computing element such as a microcontroller.

As the change in the electrostatic capacitance caused by the approach or contact of the driver's finger to any one of the multiple operation accepting areas 122 is detected by an associated electrode 123, the processing device outputs a signal for executing the operation of the controlled device associated with that operation accepting area 122. As long as the signal indicates the approach or contact of the finger to the operation accepting area 122, the signal may not be adapted to directly cause the controlled device to perform an operation as associated.

The input device 12 includes multiple border forming members 124. The multiple border forming members 124 extend radially from the central area 121. In this example, each of the multiple border forming members 124 has an elongated shape.

As illustrated in FIG. 3, each of the multiple border forming members 124 defines a border between two adjacent operation accepting areas 122a included in the multiple operation accepting areas 122. In addition, one border forming member 124a forms, together with another border forming member 124b, a borderless portion 125 having a width W to such an extent that the driver's finger 21 is not allowed to move to the central area 121 from each of the two adjacent operation accepting areas 122a.

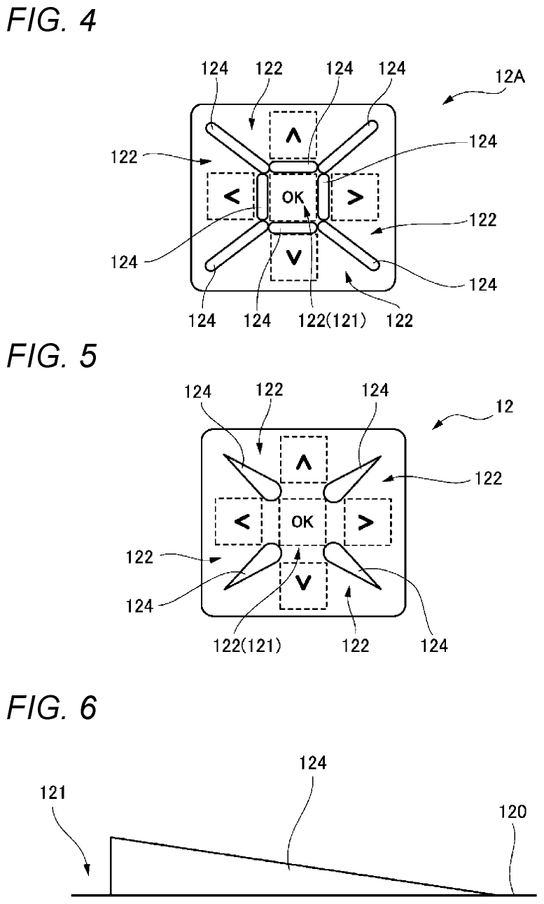

In order to prevent unintended contact or movement of the finger 21 to a certain operation accepting area 122, it is conceivable that each of the multiple operation accepting areas 122 is surrounded so as to avoid formation of borderless portion, as in a comparative exemplary input device 12A illustrated in FIG. 4. However, since such a configuration exhibits a complicated or crowded appearance, not only the product appeal would be diminished, but also the manufacturing cost would be increased due to complexity of the structure.

On the other hand, according to the configuration of the present exemplary embodiment, each of the multiple border forming members 124 can restrict the movement of the finger 21 between the adjacent operation accepting areas 122. In addition, it is possible to restrict the movement of the finger 21 from each operation accepting area 122 to the central area 121 while forming the borderless portion 125 between each operation accepting area 122 and the central area 121. As a result, although the unintended contact or movement of the finger 21 to a certain operation accepting area 122 can be prevented, not only the product appeal can be improved with a sophisticated appearance, but also the increase of the manufacturing cost can be suppressed with a simplified structure. Accordingly, it is possible to improve the convenience of the steering device 10 equipped with the input device 12 adapted to control multiple operations of the controlled device.

The above advantage become more pronounced in a case where one of the multiple operation accepting areas 122 is disposed in the central area 121 as in the present exemplary embodiment.

Each of the multiple border forming members 124 can be configured to have such a shape that changes in accordance with a distance from the central area 121, as long as it is protruded from the operation accepting face 120. The change in shape may be continuous or gradual.

In the configuration illustrated in FIG. 5, a width dimension of the border forming member 124 in a direction orthogonal to the longitudinal direction thereof is changed in accordance with a distance from the central area 121. Specifically, the width dimension decreases as the distance from the central area 121 increases.

In the configuration illustrated in FIG. 6, a height dimension of the border forming member 124 is changed in accordance with the distance from the central area 121. Specifically, the height dimension decreases as the distance from the central area 121 increases.

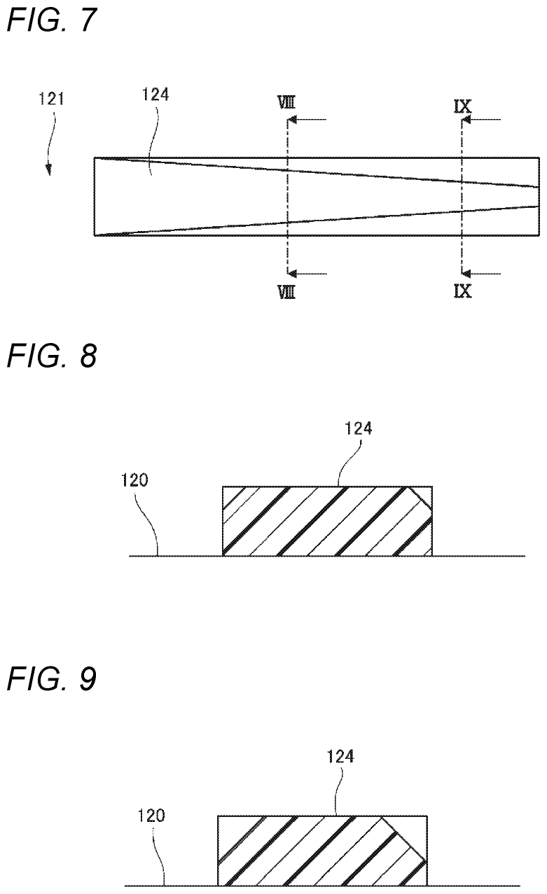

In the configuration illustrated in FIGS. 7 to 9, a cross-sectional shape of the border forming member 124 in a direction orthogonal to the longitudinal direction thereof is changed in accordance with a distance from the central area 121. FIG. 8 illustrates a cross-section taken along the line VIII-VIII in FIG. 7 when viewed from the arrowed direction. FIG. 9 illustrates a cross-section taken along the line IX-IX in FIG. 7 when viewed from the arrowed direction. In this example, as the distance from the central area 121 increases, a chamfered amount of corner portions increases, so that a cross-sectional area decreases. The chamfering may be performed to form a curved face.

The change in the shape of the border forming member 124 may be realized by a combination of two or more of the width dimension, the height dimension, and the cross-sectional shape described above.

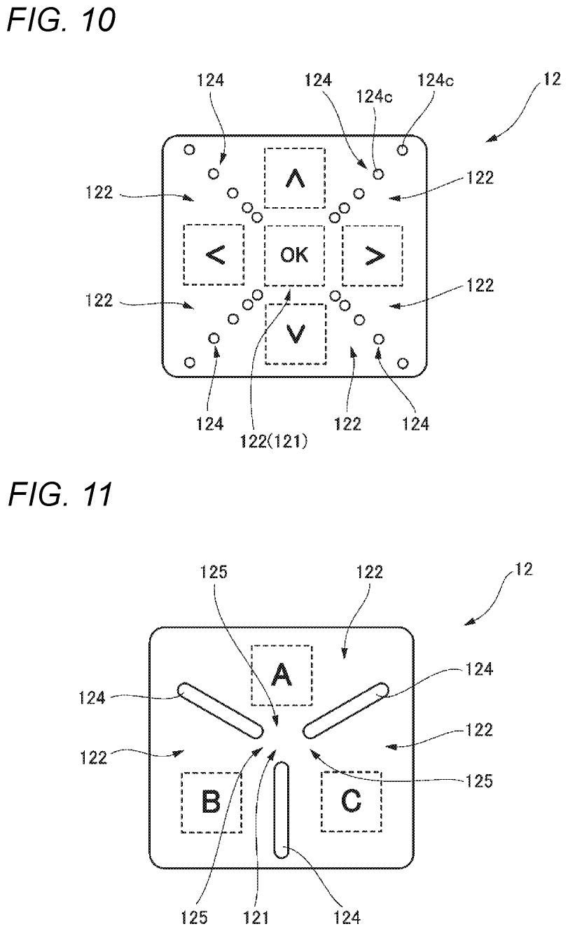

As illustrated in FIG. 10, each of the multiple border forming members 124 may include multiple sub-border forming members 124c that are independent from one another. In this example, as a distance from the central area 121 increases, a distance between adjacent ones of the sub-border forming members 124c increases.

Additionally or alternatively, the multiple sub-border forming members 124c may be configured to have such a shape that changes in accordance with the distance from the central area 121.

The foregoing description of various configurations is provided merely by way of illustration to facilitate understanding of the presently disclosed subject matter. Each of the above exemplary configurations may be appropriately modified or combined with another exemplary configuration within the scope of the presently disclosed subject matter.

In the input device 12 according to the above exemplary embodiment, the operation accepting area 122 is provided also in the central area 121. However, the operation accepting area 122 of the central area 121 may be omitted.

The input device 12 according to the above exemplary embodiment includes five operation accepting areas 122 and four border forming members 124. Five is an exemplary first number. Four is an exemplary second number. As long as the first number is no less than three and the second number is no greater than the first number, the number and arrangement of the multiple operation accepting areas 122 and the multiple border forming members 124 can be appropriately determined according to the specification of the input device 12.

FIG. 11 illustrates another exemplary configuration of the input device 12. In this example, three operation accepting areas 122 and three border forming members 124 are provided. The operation accepting area 122 is not provided in the central area 121.

In the above exemplary embodiment, the input device 12 is disposed at a position capable of being operated with a finger of a left hand of the driver. Additionally or alternatively, as illustrated in FIG. 1, the input device 12 may be disposed at a position capable of being operated with a finger of a right hand of the driver.

In the above exemplary embodiment, the contact of the driver's finger 21 with respect to the operation accepting area 122 is detected based on change in the electrostatic capacitance at the electrode 123. However, the contact of the driver's finger 21 with respect to the operation accepting area 122 may be detected with a pressure-sensitive sensor or an optical sensor.

The shape of the steering member 11 need not be annular. As long as the turning radius R about the rotation axis A and the turning path P of the grip 112 can be defined, the shape of the steering member 11 may be arbitrary. The grip 112 may have a shape in which a portion gripped by a left hand of the driver and a portion gripped by a right hand of the driver are independent from each other.

The input device 12 may be equipped with a steering device for changing the traveling direction of a mobility other than the vehicle. Examples of another mobility include a railway, a ship, and an aircraft. The function other than the direction indicating function and the controlled operation associated with the function may be appropriately determined according to the specification of the mobility.

The input device 12 need not be installed in a steering device of a mobility. For example, a controller equipped with the shaft 111 and the grip 112 can be used to control movements of an object to be displayed on a display of a simulator device for training control of a mobility, or a display of a game device in an amusement facility. Each of the multiple operation accepting area 122 can be used by a user to select one of multiple functions adapted to be executed by the object, and to execute an operation associated with the selected function. In this case, the controller is an exemplary operation control device. The movement of the object is an exemplary first controlled operation. The operation associated with each function adapted to be executed by the object is an exemplary second controlled operation.

1. An operation control device, comprising:
a shaft configured to allow a rotation about a rotation axis, the rotation being associated with a first controlled operation;
a grip adapted to be turned about the rotation axis along a turning path, and t be gripped by a hand of a user; and
an input device disposed between the shaft and the grip when viewed from a direction along the rotation axis,
wherein the input device includes:
a first number of operation accepting areas associated with different second controlled operations, the first number being no less than three; and
a second number of border forming members each having a protruded shape, the second number being no greater than the first number;
wherein the operation accepting areas are disposed so as to surround a central area;
wherein the border forming members extend radially from the central area;
wherein each of the border forming members defines a border of two adjacent ones of the operation accepting areas;
wherein one of the border forming members forms, together with another one of the border forming members, a borderless portion having a width to such an extent that a finger of the driver is not allowed to move to the central area from each of the two adjacent ones of the operation accepting areas.

2. The operation control device according to claim 1,
wherein one of the operation accepting areas is provided in the central area.

3. The operation control device according to claim 1,
wherein each of the border forming members has such a shape that changes in accordance with a distance from the central area.

4. The operation control device according to claim 1,
wherein each of the border forming members includes multiple sub-border forming members; and
wherein at least one of a shape and an interval of the sub-border forming members changes in accordance with a distance from the central area.

5. The operation control device according to claim 1,
wherein each of the operation accepting areas is configured to detect change in electrostatic capacitance caused by contact or approach of the finger.

6. The operation control device according to claim 1,
wherein the first controlled operation is changing a travel direction of a mobility; and
wherein the second controlled operation and the third controlled operation are different operations of at least one controlled device installed in the mobility.

7. An input device adapted to be equipped with an operation control device that includes: a shaft configured to allow a rotation about a rotation axis, the rotation being associated with a first controlled operation; and a grip adapted to be turned about the rotation axis along a turning path, and to be gripped by a hand of a user, the input device being adapted to be disposed between the shaft and the grip when viewed from a direction along the rotation axis, and comprising:
a first number of operation accepting areas associated with different second controlled operations, the first number being no less than three; and
a second number of border forming members each having a protruded shape, the second number being no greater than the first number,
wherein the operation accepting areas are disposed so as to surround a central area;
wherein the border forming members extend radially from the central area;
wherein each of the border forming members defines a border of two adjacent ones of the operation accepting areas;
wherein one of the border forming members forms, together with another one of the border forming members, a borderless portion having a width to such an extent that a finger of the driver is not allowed to move to the central area from each of the two adjacent ones of the operation accepting areas.
